(19) United States
(12) Patent Application Publication
(10) Pub. No.: US 2012/0330534 A1
(43) Pub. Date: Dec. 27, 2012

(54) ENHANCED EFFICIENCY AND POLLUTANT CONTROL BY MULTI-VARIABLE ENGINE OPERATION CONTROL

(76) Inventors: James M. Cleeves, Redwood City, CA (US); Michael A. Willcox, Redwood City, CA (US)

(21) Appl. No.: 13/535,165

(22) Filed: Jun. 27, 2012

Related U.S. Application Data
(60) Provisional application No. 61/501,594, filed on Jun. 27, 2011.
(60) Provisional application No. 61/501,654, filed on Jun. 27, 2011.

(51) Int. Cl. F02D 41/30; F02D 19/08; F02D 41/26

(52) U.S. Cl. 701/104

(57) ABSTRACT

Based on one or more monitored operation parameters of an internal combustion engine, a set of engine operation conditions necessary to provide combustion stability in a combustion volume of the engine, optimized fuel efficiency, and minimized production of pollutants such as nitrogen oxides, carbon monoxide, and unburned hydrocarbons can be determined. The new set of engine operation conditions can be dynamically implemented in response to changing engine loads and changing engine speeds to maintain a combustion mixture and combustion conditions within a combustion chamber of the engine constrained flammability limits, pollutant generation rates, and fuel efficiency considerations. Related articles, systems, and methods are described.

### RELATED APPLICATIONS

The current application claims priority under 35 U.S.C. §119(e) in the United States and under the Paris Convention in countries outside of the United States to U.S. provisional applications for patent Nos. 61/501,594 and 61/501,654, respectively entitled “Enhanced Efficiency And NOₓ Control By Multi-Variable Control Of Engine Operation” and “High Efficiency Internal Combustion Engine,” both of which were filed on Jun. 27, 2011. The current application is also related to co-pending and co-owned U.S. Pat. No. 7,559,298 entitled “Internal Combustion Engine,” to U.S. Pat. No. 7,098,581 entitled “Spark Plug,” to co-pending and co-owned international patent application no. PCT/US2011/027775 entitled “Multi-Mode High Efficiency Internal Combustion Engine,” to co-pending and co-owned U.S. patent application Ser. No. 12/720,457 entitled “Over-Compressed Engine,” to co-owned and co-pending international patent application no. PCT/US2010/046095 entitled “High Swirl Engine,” to co-pending and co-owned international patent application no. PCT/US2011/055457 entitled “Single Piston Sleeve Valve with Optional Variable Compression Ratio,” to co-pending and co-owned international patent application no. PCT/US2011/055502 entitled “Control of Combustion Mixtures and Variability thereof with Engine Load,” and to co-pending and co-owned international patent application no. PCT/US2011/055486 entitled “Variable Compression Ratio System for Opposed-Piston and Other Internal Combustion Engines, and Related Methods of Manufacture and Use.” The disclosure of each document listed in this paragraph is incorporated by reference herein in its entirety.

### TECHNICAL FIELD

The subject matter described herein relates to internal combustion engines, and in particular, to internal combustion engines that are dynamically controlled to enhance efficiency using variability of one or more engine operation parameters potentially including, but not limited to, compression ratio, valve timing, ignition timing, ignition energy, combustion mixture richness, and exhaust gas recirculation.

### BACKGROUND

Internal combustion engines are commonly used to provide power for motor vehicles as well as in other applications, such as for example for lawn mowers and other agricultural and landscaping equipment, power generators, pump motors, boats, planes, and the like. For a typical driving cycle of a motor vehicle, the majority of fuel consumption may occur during low-load and idling operation of the vehicle's internal combustion engine. Similarly, other uses of internal combustion engine may also be characterized by more frequent use at a power output less than that provided at a wide open throttle condition. However, due to mechanical friction, heat transfer, throttling, and other factors that can negatively impact performance, spark ignition internal combustion engines inherently have better efficiency at high loads and poorer efficiency at low loads.

Efficiency at lower engine loads can be improved in some instance by increasing a compression ratio of the engine. The compression ratio is a measure of the degree to which a combustion mixture is compressed before ignition that is defined as the expanded volume of the engine combustion chamber divided by the compressed volume of the engine combustion chamber. For example, the compression ratio, CR, can generally be defined as

$$CR = \frac{\frac{π}{4} {b}^{2} s + {V}_{c}}{{V}_{c}} \qquad ( 1 )$$

In equation 1, b is the diameter of the cylinder bore, s is the stroke length of the piston, and V_{c} is the clearance volume within the cylinder, which includes the minimum volume of the space at the end of the compression stroke, i.e. when the piston reaches top dead center (TDC). A high compression ratio can enable an engine to extract more mechanical energy from a given mass of a combustion mixture due to a higher thermal efficiency. Using a higher compression ratio, the same combustion temperature can be reached with less fuel while giving a longer expansion cycle, creating more mechanical power output and lowering the exhaust temperature.

For a fixed piston stroke length and cylinder bore, the compression ratio can be increased by reducing the clearance volume and decreased by enlarging the clearance volume, for example by changing an internal geometry of the cylinder. One example of an approach to changing an internal geometry of the cylinder for a conventional engine configuration to provide variable compression ratio operation can include use of a moveable junk head and sleeve valve engine configuration such as are described international application no. PCT/US2011/055457. A conventional engine can alternatively include a crankshaft and engine block that are translatable relative to each other to vary the closest approach of a piston to a cylinder head that is fixed in relation to the engine block. Other variable compression ratio options, for example for an opposed piston engine, include translation of one (or optionally both) of the crankshafts that rotate under influence of the opposed pistons, changing the phase of one or both of the opposed pistons such that both pistons do not reach their respective top dead center positions simultaneously, and the like. Non-limiting examples of opposed piston engines including one or more features relating to variable combustion ratio capabilities are described in U.S. Pat. No. 7,559,298 and in international application PCT/US2011/055486.

A high compression ratio in a standard Otto cycle engine generally results in the piston performing a longer expansion in the power stroke, and consequently more work, in comparison to the same engine running at a lower compression ratio. Compression ratios of gasoline powered automobiles using gasoline with an octane rating of 87 typically range between about 8.5:1 and 10:1. The maximum compression ratio achievable by an engine can be limited by auto-ignition (i.e., combustion that occurs before the flame front, as ignited by spark plug, arrives) and the audible and potentially damaging result. Auto-ignition can occur as a result of disassociation of the fuel into more easily combustible molecular fragments when the mixture is exposed to high temperatures for a sufficiently long period of time. The high temperature exposure can result in these fragments initiating an uncontrolled explosion outside the envelope of the normal combustion.

The resulting pressure waves inside a combustion chamber due to this rapid energy release can cause engine knock, which is both potentially damaging and objectionable to the operator. Knock is a specific result caused by the more general issue of auto-ignition. In this document, auto-ignition refers to instances in which the ignition occurs spontaneously, either before or after the spark event, and not in a controlled or intended manner consistent with optimal engine operation. Auto-ignition as used herein need not result in knock, but is more generally applicable to ignition occurrences other than at a desired time or a desired place within the combustion chamber.

### SUMMARY

In one aspect, an internal combustion engine includes a combustion chamber, an air intake, a physical throttle controlling flow of air through the air intake into the combustion chamber, a master controller. The master controller can perform operations including, but not limited to first increasing, in response to a first load control input from an engine operator demanding an engine power output to satisfy an imposed engine load, a position of the physical throttle controlling flow of air through the air intake into the combustion chamber; providing, during the first increasing, a determined amount of a diluent to the combustion chamber, the amount of the diluent having been computed as a function of a current engine load, a current engine speed, a current engine brake efficiency, and a current emissions output; stopping the first increasing upon reaching a wide open throttle position at which the physical throttle allows a maximum possible air flow delivered to the combustion chamber; and second increasing, when the demanded engine power output to satisfy the imposed engine load exceeds a maximum engine power output attainable at the wide open throttle position of the physical throttle, an amount of fuel delivered to the combustion chamber, the second increasing in the amount of fuel occurring without further increases beyond the maximum possible air flow delivered to the combustion chamber at the wide open throttle position.

In an interrelated aspect, a method includes first increasing, in response to a first load control input from an engine operator demanding an engine power output to satisfy an imposed engine load, a position of a physical throttle controlling flow of air through an air intake into a combustion chamber of an internal combustion engine; providing, during the first increasing, a determined amount of a diluent to the combustion chamber, the amount of the diluent having been computed as a function of a current engine load, a current engine speed, a current engine brake efficiency, and a current emissions output; stopping the first increasing upon reaching a wide open throttle position at which the physical throttle allows a maximum possible air flow delivered to the combustion chamber; and second increasing, when the demanded engine power output to satisfy the imposed engine load exceeds a maximum engine power output attainable at the wide open throttle position of the physical throttle, an amount of fuel delivered to the combustion chamber, the second increasing in the amount of fuel occurring without further increases beyond the maximum possible air flow delivered to the combustion chamber at the wide open throttle position.

In optional variations, one or more of the following features can be included in any feasible combination.

A compression ratio can be first dynamically varied throughout at least one of the first increasing and the second increasing, the first dynamically varying at least in part maintaining a stable combustion mixture within a flammability limit, avoiding auto-ignition of the combustion mixture within the combustion chamber, and providing a maximum fuel efficiency for any specific combination of a current engine load and a current engine speed.

The providing can optionally include second dynamically varying at least one of an operation mode of one or more valves to increase flow of the diluent to achieve the maximum amount of the diluent and the physical throttle position to increase the flow of intake air to the combustion chamber. The second dynamically varying can at least in part maintain a stable combustion mixture within a flammability limit, avoid auto-ignition of the combustion mixture within the combustion chamber, and provide a maximum fuel efficiency for any specific combination of a current engine load and a current engine speed. The varying of the operation mode can optionally include at least one of varying a valve timing, a valve lift, and a valve opening duration for at least one of a exhaust gas recirculation valve and an air intake valve.

The first increasing and the second increasing can optionally include third dynamically varying an air-to-fuel ratio in the combustion chamber to achieve at least one of a maximum fuel efficiency, a minimum generation of hydrocarbons, a minimum generation of carbon monoxide, and a minimum generation of nitrogen oxides and to at least in part maintain a stable combustion mixture within a flammability limit and to avoid auto-ignition of the combustion mixture within the combustion chamber for any specific combination of a current engine load and a current engine speed.

The first increasing and the second increasing can optionally include fourth dynamically varying at least one of an ignition timing for delivery of ignition energy from one or more ignition sources, a duration of delivery of the ignition energy from the one or more ignition sources, a number of the one or more ignition sources that delivers the ignition energy, and a location of the number of the one or more ignition sources that delivers the ignition energy to at least part maintain a stable combustion mixture within a flammability limit, avoid auto-ignition of the combustion mixture within the combustion chamber, and provide a maximum fuel efficiency for any specific combination of the current engine load and the current engine speed.

The maximum amount of the diluent can be determined, and the determining can optionally include computing the function as constrained by at least a flammability limit of the combustion mixture and minimization of NO_{X} production at the current engine load and the current engine speed.

The flammability limit can optionally be defined by at least one of a coefficient of variation (COV) of a net indicated mean effective pressure (NIMEP) in the combustion chamber, a 0-10% apparent heat release angle of crankshaft rotation, a lowest normalized value (LNV) of net indicated mean effective pressure (NIMEP), and a COV of torque. Alternatively or in addition, the flammability limit can optionally be defined by at least one of the COV of the NIMEP being less than approximately 8%, the 0-10% apparent heat release angle being less than approximately 40° of crankshaft rotation, the LNV of the NIMEP being greater than approximately 75%, and the COV of torque being less than approximately 5%.

A non-linear correlation can optionally be used between the position of the physical throttle and the first load control input. The overall maximum engine output power can optionally be achieved at a maximum power air-to-fuel ratio that comprises one of a stoichiometric ratio and a richer than stoichiometric ratio. The diluent can optionally include at least one of air and recirculated exhaust gases. The diluent can optionally include recirculated exhaust gases that are either cooled or uncooled. The second increasing can optionally be stopped upon reaching either of an overall maximum engine output power or a maximum permissible emissions limit for one or more of NO_{X}, hydrocarbons, and carbon monoxide. Fuel can optionally be delivered to the combustion chamber using a fuel delivery system that includes at least one of a fuel injection system and a carburetor capable of varying and controlling a delivered air-to-fuel ratio independently of air flow through an air intake as controlled by the physical throttle.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a chart showing relationships between fraction of total fuel consumed, engine speed, and engine load (also referred to as output power) for an example vehicle on an example drive cycle;

FIG. 2 is a diagram showing a cross-sectional view of an opposed piston engine having one or more features consistent with implementations of the current subject matter;

FIG. 3 is a diagram showing a cross-sectional view of an engine incorporating poppet valves and having one or more features consistent with implementations of the current subject matter;

FIG. 4 is a diagram showing a cross-sectional view of an engine incorporating actively cooled poppet valves and having one or more features consistent with implementations of the current subject matter;

FIG. 5 is a process flow diagram illustrating a method having one or more features consistent with the current subject matter; and

FIG. 6 is a block diagram showing control systems that can be used in conjunction with an internal combustion engine consistent with implementations of the current subject matter.

When practical, similar reference numbers denote similar structures, features, or elements.

### DETAILED DESCRIPTION

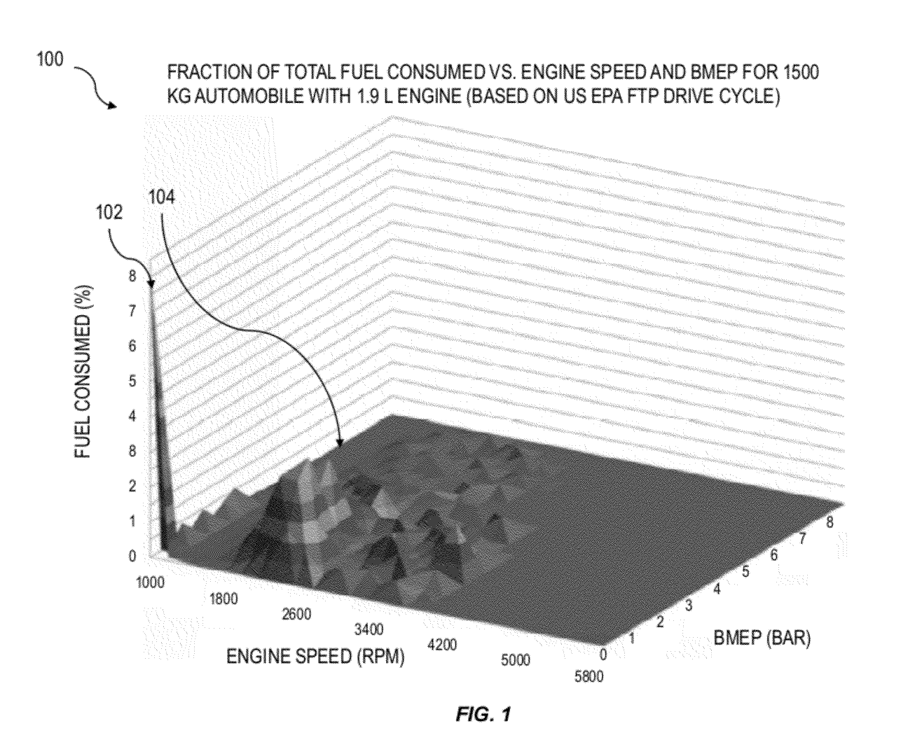

FIG. 1 shows a chart 100 illustrating fractions of total fuel consumed by a 1500 kg automobile with a 1.9 L displacement engine as a function of engine speed and BMEP using the United States Environmental Protection Agency's Federal Test Procedure city drive cycle. As shown in the chart 100, the majority of fuel consumption for this drive cycle occurs in two regions: in a first range 102 at idle or near idle conditions 102 and in a second range 104 between about 0.5 and 3 bar BMEP and between about 1000 and 2800 RPM engine speeds.

Consistent with one or more implementations of the current subject matter, an engine can employ very fuel-lean combustion mixtures at light engine loads to realize efficiency benefits, particularly in relation to closer mapping of high efficiency operation modes of the engine to real world driving conditions. For example, an engine can operate at a higher throttle condition at light engine loads, which can reduce pumping losses and increase efficiency. However, such an approach can be limited in terms of peak power output for a given displacement. As power requirements increase, the throttle can be opened further. Eventually, the engine can be operated at a highly lean condition at wide open throttle (WOT). This operating regime can, in some implementations of the current subject matter, be useful in a load range between approximately 0 and 6 bar BMEP. In order to generate power up to a peak power of approximately 9 to 10 bar BMEP, the combustion mixture can be increased in fuel richness. However, due to the high compression ratio employed to maintain stable combustion at the lean operating conditions of the first operating mode, as the combustion mixture is progressively enriched, the spark timing can be retarded to avoid auto-ignition (e.g. knock), which can potentially damage the engine.

A variety of factors in addition to high compression ratios can affect the occurrence of knock in particular and auto-ignition in general in an internal combustion engine. In general, low octane fuels may spontaneously ignite at lower temperatures than high octane fuels. Hot wall or piston temperatures in engines can also tend to increase the heating of the combustion mixture, thereby increasing the tendency of the fuel to auto-ignite, as can localized hot spots, such as around the exhaust valve, which may cause localized heating of the combustion mixture and auto-ignition initiating in the vicinity of the hot spots. A fast burn rate of the fuel-air mixture, for example due to high turbulence, which promotes good mixing and rapid burning of the fuel, can reduce the likelihood of spontaneous ignition. However, high inlet flow field turbulence can also increase the temperature rise in the inlet combustion mixture, which increases the likelihood of spontaneous ignition. Increasing the quantity of fuel in the mixture up to a point can increase the energy released and hence the pressure and temperature of the end gas, which can affect the tendency to knock. Advanced ignition timing can also increase pressures and temperatures, thereby contributing to a tendency for auto-ignition under some conditions.

A second concern in modern engine design is generation of combustion by-products that act as atmospheric pollutants. Conventional internal combustion engines typically run at temperatures substantially higher than is necessary to cause nitrogen (N₂) and oxygen (O₂) to spontaneously react to form oxides of nitrogen such as nitric oxide (NO) and nitrogen dioxide (NO₂), which are collectively referred to as NO_{X}. These compounds are irritants in their own right and are also precursors to tropospheric ozone, which is a primary component of smog. NO_{X} can also serve as a precursor to nitrous oxide (N₂O), which is powerful green house gas. As such, NO_{X} emissions from engines are now tightly controlled. Other pollutants commonly formed in internal combustion engines can include unburned hydrocarbons and carbon monoxide, both of which result from incomplete combustion of fuel.

In many traditional engines, NO_{X} emissions can be reduced by passing the exhaust stream through a catalyst to cause decomposition of combustion-formed NO_{X} molecules into nitrogen and water or carbon dioxide via a reduction reaction. In a typical spark ignited engine, for example, a three-way catalyst is used to, in one mode, catalyze the oxidation of residual hydrocarbons and carbon monoxide (CO) into water (H₂O) and carbon dioxide (CO₂) and, in another mode, to catalyze a reduction reaction that converts NO_{X} to nitrogen gas (N₂) and water. This approach can be very effective but requires the engine to be run within a very narrow ratio of air-to-fuel ratios of the combustion mixture that is close to a stoichiometric ratio. The combustion mixture can be run very slightly rich (excess fuel) to yield hydrocarbons and CO in the exhaust and then slightly lean (excess O₂) to leave excess O₂ to be able to oxidize the unburned hydrocarbons and CO into H₂O and CO₂. Alternatively, in a lean running engine like a diesel, additives can be put into the exhaust to supply the excess hydrogen radicals needed for the reduction of NO_{X}. Such additives can include excess fuel, ammonia (NH₃), or the like.

NO_{X} emissions control technologies typically add either or both of complexity and cost to an engine, and can also require the engine to be run in a mode that is not as efficient as it could be. Accordingly, implementations of the current subject matter provide operational modes of an internal combustion engine that allow operation at a peak operating temperature below that at which N₂ and O₂ will begin to spontaneously react to form NO_{X}. One or more of the operational modes can also provide enhanced efficiency by varying one or more of several control variables based on engine operational data. While operational modes of engines consistent with implementations of the current subject matter can be tuned to encourage acceptable emissions of carbon monoxide and unburned hydrocarbons, prevention (or at least substantial reduction) in the rate of production of NO_{X} can allow achievement of pollutant control standards using a two-way catalyst that converts CO and hydrocarbons to carbon dioxide and water in the presence of excess oxygen. Such a catalyst is not constrained to use at or near stoichiometric air-to-fuel ratios. As such, engines consistent with implementations of the current subject matter can be capable of realizing the benefits of running under lean combustion conditions. In some examples, the excess oxygen present in a lean combustion mode can promote more complete conversion of fuel to carbon dioxide in the combustion chamber.

Some currently available engines, such as for example an opposed piston engine as described in U.S. Pat. No. 7,559,298, may be capable of extremely lean operation, for example at an air-to-fuel ratio of approximately 1.4 to 1.8 times the stoichiometric ratio (e.g. λ˜1.4 to 1.8). Combustion temperatures under such conditions can in some examples be maintained lower than the transition temperature at which formation of nitrogen oxides begins. This approach can produce tailpipe emissions that allow a small vehicle to meet the grams of NOx per kilometer traveled emission specifications. These tailpipe emissions levels are typically not sufficiently low to allow a larger vehicle that would need more power to meet those same gram per km specifications. For such heavier vehicles, exhaust gas can be recirculated consistent with one or more implementations of the current subject matter to provide a diluent without adding oxygen.

As a general overview, implementations of the current subject matter include internal combustion engines, as well as methods for making and operating such engines, that feature the ability to control one or more of an air-to-fuel ratio of a combustion mixture within a combustion chamber of the engine, a variable compression ratio within the combustion chamber a timing of the delivery of ignition energy to the combustion mixture from one or more ignition sources, a variable timing of operation of one or more valves providing air and/or fuel to the combustion chamber and/or removing exhaust gases from the combustion chamber, an amount of dilution of the combustion mixture by one or more of air and a relatively inert diluent (e.g. recirculated exhaust gases), an amount of turbulent kinetic energy imparted to the combustion mixture, a spatial distribution over which ignition energy is provided to the combustion mixture from the one or more ignition sources, and the like. One or more of the above-noted features can be used in combination to allow an engine to operate efficiently and reliably in a lean combustion mixture regime that limits combustion temperatures sufficiently to eliminate the need for post-combustion treatment of NO_{X}, which can result in substantial savings the design of a pollution control system, at least because treatment of carbon monoxide and unburned hydrocarbons can be accomplished using a two-way catalyst.

Previously available engines operating in a dilute combustion mixture regime have generally encountered difficulties in consistently igniting such dilute combustion mixtures. As used herein, the term “dilute” refers to the addition of a diluent (e.g. a gas other than fuel) to the combustion chamber such that the charge density (e.g. amount of fuel present in a volume of the combustion mixture) as the combustion mixture is compressed is lower than it would be absent the presence of the diluent. Further difficulties with conventional approaches at lower power levels can relate to the required reduction of trapped mass by means of a throttle or valve event, which causes the charge density at the delivery of ignition energy from an ignition source and at the end of a compression stroke to be reduced. The resulting lower charge densities can be more difficult to ignite consistently, for example due to a lack of sufficient fuel molecules in a region surrounding the spark plug or other ignition source to overcome the cooling effect of the non-burning mixture nearby. The non-burning mixture can then cool the flame enough that it extinguishes. The traditional approach to resolving this instability is to add more fuel, either locally in a stratified charge mode or globally. However, addition of more fuel can cause regions with the higher levels of fuel to reach NO_{X} formation temperatures.

An internal combustion engine consistent with one or more implementations of the current subject matter can provide improved fuel efficiency and reduced NO_{X} and other pollutant emissions across a broad range of engine loads and speeds thereby resulting in efficiency gains and reduced emissions for a typical drive cycle for a motor vehicle. Other uses of internal combustion engines, including but not limited to agricultural and landscaping equipment, power generators, pump motors, boats, planes, and the like, can also benefit from the provided improvements over a larger range of engine loadings. One or more of these or optionally other benefits can be achieved through an approach that involves monitoring one or more operation parameters of an internal combustion engine and determining, based on the monitored operation parameters, a set of engine operation conditions necessary to provide combustion stability in a combustion volume of the engine, optimized fuel efficiency, and minimized production of nitrogen oxides. The set of engine operation conditions can include one or more of an ignition timing in the combustion volume, an ignition energy provided within the combustion volume, a compression ratio experienced by a combustion mixture within the combustion volume, an air-to-fuel ratio delivered within the combustion volume, an amount of recirculated exhaust gas added to the combustion mixture in the combustion volume, a compression ratio, and a valve timing. The new set of engine operation conditions can be dynamically implemented, for example to transition from a first set of engine operation conditions during a first engine cycle to the new set of engine operating conditions during a second engine cycle. One example of an internal combustion engine consistent with one or more implementations of the current subject matter can include a controller device that receives the monitoring data discussed in the preceding paragraph and that determines the set of engine operation conditions necessary to provide the desired effects.

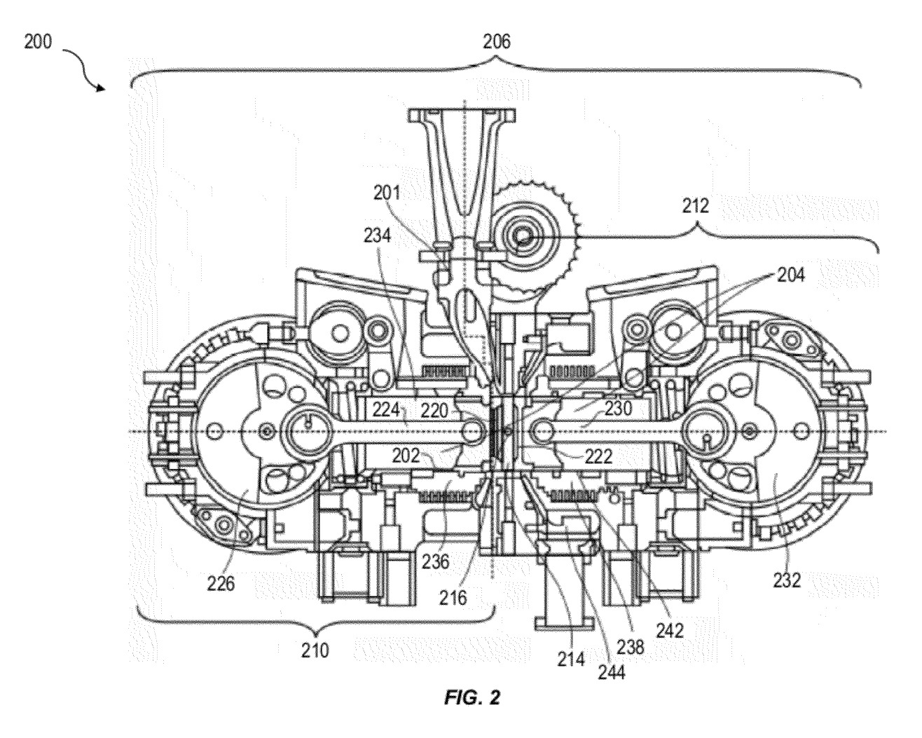

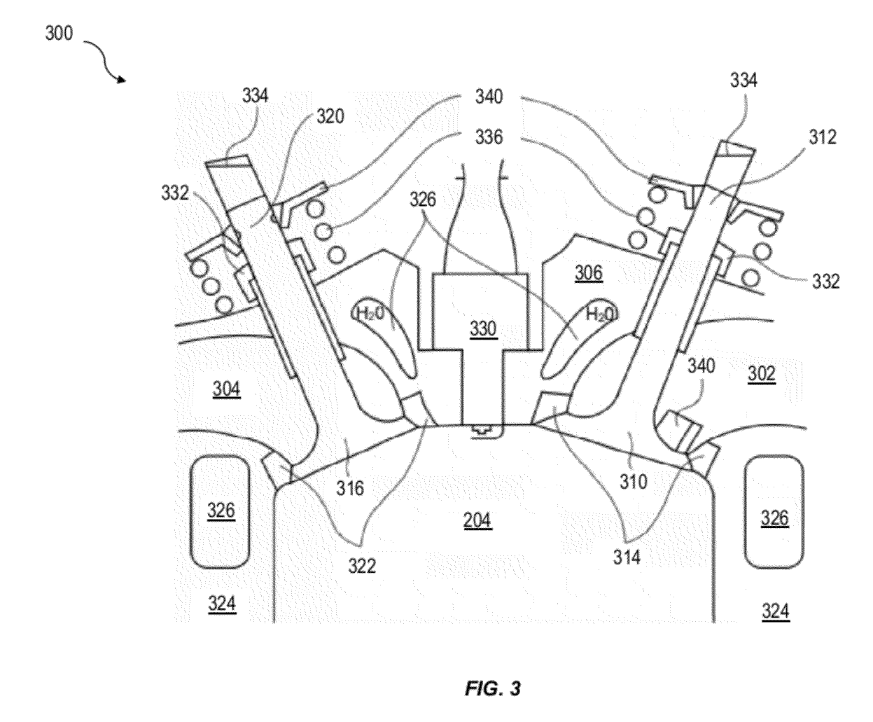

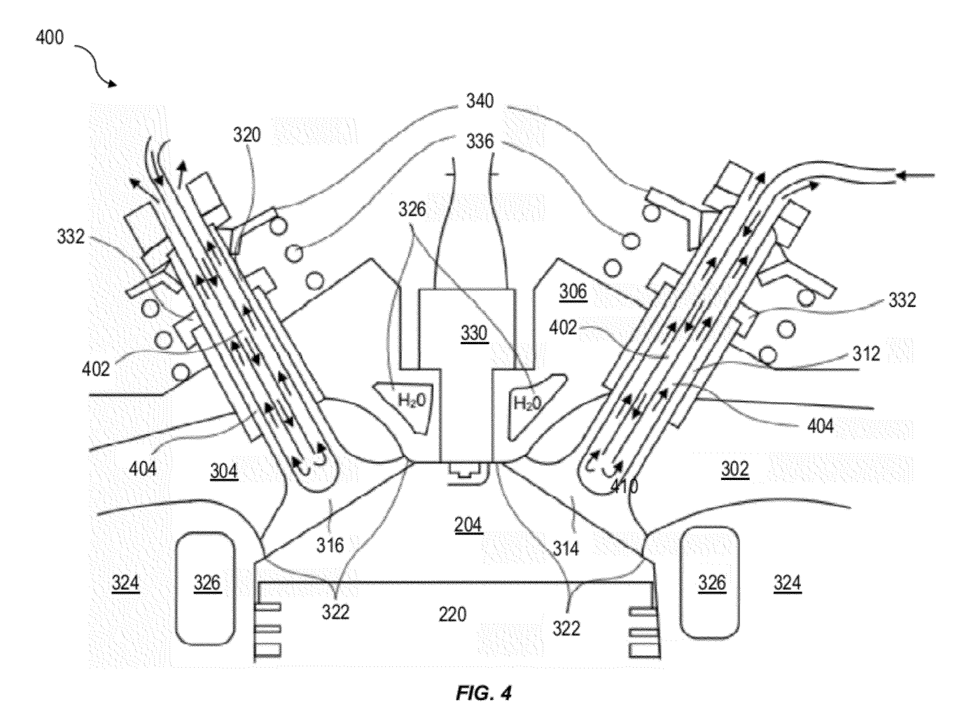

In implementations of the current subject matter, a four-stroke, spark-ignited, opposed piston engine can include reciprocating sleeve valves to control one or more of intake and exhaust ports in communication with a combustion chamber. Such an engine can optionally include variable compression ratio (VCR) and variable valve timing (VVT). VCR can be used to reduce a compression ratio according to one or more factors including an air-to-fuel ratio of the combustion mixture to avoid auto-ignition or knock at higher engine loads. VVT can be used to reduce pumping losses, for example by adjusting one or more of the lift (e.g. amount of opening), timing, and duration of operation of one or more valves in an internal combustion engine. Other implementations of the current subject matter can include engine configurations in which one or more pistons operate in a non-opposed piston arrangement. Such engines, three non-limiting, illustrative examples of which are shown in FIG. 2, FIG. 3, and FIG. 4, can include one or more poppet valves and/or one or more sleeve valves to control one or more of the intake and exhaust ports in communication with the combustion chamber.

FIG. 2 shows a cross-sectional view of at least part of an internal combustion engine 200 having an opposed piston geometry that is capable of implementing features of the current subject matter. Further details of this engine and similar engines are set forth in U.S. Pat. No. 7,559,298 and in international patent application no. PCT/US2010/046095. As shown in FIG. 2, an air intake inlet port 201 delivers air that is delivered either alone or as part of a combustion mixture into a cylinder 204 that is defined by an engine body 206. As shown in FIG. 2, the engine body 206 can include a left casting 210 and a right casting 212 that are mounted to a center connecting piece 214 which can be in the form of a ring. The center connecting piece 214 can also include one or more spark plug sleeves 216 through which spark plugs can be inserted. The engine 200 is configured such that a left piston 220 and a right piston 222 reciprocate within the cylinder 204 along a centerline C of the cylinder 204. The left piston 220 is connected to a left connecting rod 224, which in turn connects to a left crankshaft 226. The right piston 222 is connected to a right connecting rod 230, which in turn connects to a right crankshaft 232. The left piston 220 reciprocates within the cylinder 204, and is slidably movable to the left and right along the cylinder wall 234. The right piston 222 also reciprocates within the cylinder 204, and is slidably movable to the left and right along the cylinder wall 234.

FIG. 2 shows a piston configuration in which two pistons are arranged in an opposing manner in the same cylinder 204 so that the combustion chamber at top dead center (TDC) is defined primarily by the pistons 220, 222 and the cylinder walls 234. In other engine designs consistent with one or more features of the current subject matter, the cylinder walls, a piston at one end, and a cylinder head at the other end can define a combustion chamber. The diameter of the pistons 220, 222 in the engine 200 can be smaller than that of conventional pistons, and no cylinder heads are required. The omission of separate cylinder heads and use of a smaller piston diameter can provide a low surface area to volume ratio within the combustion chamber, which as noted elsewhere herein, can limit heat transfer losses from the combustion chamber. Heat that would otherwise be lost to heat transfer can instead contribute to the work performed by the pistons 220, 222 during their power stroke (e.g. making the power stroke closer to the idealized adiabatic condition). In some implementations, an advantage of the opposed piston arrangement of the engine 200 is that, by having a low surface area to volume ratio, the surface area of the combustion chamber through which heat may escape is minimized. As a result, increased heat transfer from a high velocity or high turbulence combustion mixture may have a lesser impact on the engine 200 than in other engine configurations. In some implementations, the pistons 220, 222 can include low thermal conductivity material (optionally including but not limited to cast iron and the like) due to their smaller diameter than pistons in other engine designs. Using a low thermal conductivity material can enable more of the heat generated in the combustion event to be retained in the gas and therefore available to do work.

FIG. 2 also illustrates a first coolant-path defining piece 236 associated with the left casting 210 and a second coolant-path defining piece 238 associated with the right casting 212. One or more sleeve valve bodies 240, 242 can be slidably movable to the left and right (from the FIG. 2 perspective) relative to the respective coolant-path defining pieces 236, 238. As shown in FIG. 2, a first sleeve valve body 240 is associated with the left casting 210 and a second sleeve valve body 242 is associated with the right casting 212. The first sleeve valve body 240 can function in association with the inlet port 201 and the second sleeve valve body 242 can function in association with an exhaust port 244.

In FIG. 2, the left piston 220 and right piston 222 are disposed in the cylinder 204 as they would be at top dead center (TDC), with the combustion volume, which in this example is defined by the cylinder wall 236, and the piston heads of the left piston 220 and right piston 222, at its smallest. An engine consistent with implementations of the current subject matter can be configured such that the ignition timing occurs before, at, or after the minimum combustion volume (before, at, or after top dead center) as discussed elsewhere herein.

In conventional engines, in addition to adding to the surface area of the combustion chamber, the cylinder heads house the inlet and exhaust poppet valves. These valves often define localized hot spots in the combustion chamber, possibly reaching temperatures in conventional engines that can be as high as 650° C. As noted above, localized hot spots can be a significant contributing factor to engine knock. Conventional inlet and exhaust valves can also be omitted in an engine 200 as shown in FIG. 2, and instead replaced by the inlet port 201 covered by the first sleeve valve body 240, and an exhaust port 244 covered by a second sleeve body 242. The first sleeve valve 202 reciprocates to open and close the inlet port 201. The second sleeve valve 242 reciprocates to open and close the exhaust port 244. Further details of the inlet valve, exhaust valve and sleeve valves are disclosed in the above-incorporated U.S. Pat. No. 7,559,298 and U.S. Publication No. 2011/0041799A1, but of relevance is that the inlet and exhaust valves can be configured to avoid defining localized hot spots within the combustion chamber. They remain mostly hidden by the piston crown near TDC and are also maintained at temperatures that are typically below a second target temperature of 400° C., for example using one or more approaches as discussed in more detail herein. These relatively low temperatures can reduce heat transfer to the combustion mixture, thereby increasing knock margin and enabling a higher compression ratio.

Moreover, while reducing heat transfer through the cylinder walls 234 can be desirable, it can also be important to maintain the cylinder walls 234 and other internal surfaces to which inlet air, fuel, and the air-fuel are exposed at a low enough temperature to reduce or eliminate instances of spontaneous ignition of the end gas (i.e. the last of the gas to combust) during burn. An engine can accomplish this by a cooling fluid circulating around the first and/or sleeve valve 202, 242 to remove heat. Further details of such a cooling system are disclosed in the above-incorporated U.S. Pat. No. 7,559,298, but in general, a cooling fluid can be pumped through grooves around the outer surface of the sleeve portion 202, 242. Heat can convect from the sleeve portion 202, 242 to the cooling media, and is removed by the cooling media from the system.

The engine 200 shown in FIG. 2 is merely one example of an opposed piston engine that can incorporate one or more beneficial features consistent with implementations of the current subject matter. An opposed piston with non-collinear axes of translation (e.g. a “bent” opposed piston engine) can also include one or more features described herein. Additionally, as noted above, features consistent with one or more implementations of the current subject matter can also be applied to beneficial effect in non-opposed piston engines (e.g. engines having a piston reciprocating in a cylinder that is closed at one end by a cylinder head or other structure that does not extract useful work from the expansion of the burning combustion mixture.

FIG. 3 shows an example of at least part of an engine 300 having poppet valves that control an inlet port 302 and an exhaust port 304, which are positioned in or adjacent to a cylinder head 306 of an engine having each of one or more pistons in its own cylinder 204. Flow through the inlet port 302 shown in FIG. 3 is controlled by a first poppet valve assembly including an inlet valve head 310, an inlet valve stem 312, and an inlet valve seat 314, while flow though the exhaust port 304 is controlled by a second poppet valve assembly including an exhaust valve head 316, an exhaust valve stem 320, and an exhaust valve seat 322, respectively. The cylinder block 324 around the cylinder 404 as well as the cylinder head 306 in the vicinity of the first and second poppet valves assemblies can include coolant flow channels 326 through which coolant, such as for example water, a solution of anti-freeze in water, oil, or the like can be passed to convectively remove heat generated by combustion within the combustion volume in the cylinder 204. In the configuration shown in FIG. 3, a single spark plug 330 is shown at the center of the cylinder head 306. Other positions for the ignition source 330 (e.g., one or more spark plugs, plasma sources, lasers, pre-combustion chambers, or the like) are also within the scope of the current subject matter. More than one ignition source 330 can also be used. Each valve assembly can include a valve stem seal 332, a rocker arm or valve lift arm 334 connected to one or more cams to activate (e.g. open) the valve, and a coil or spring 336 to urge the valve into a closed position against the valve seat 314 or 322. A spring retainer 340 retains the spring 336.

One or more of the valve heads 310 and 316, valve stems 312 and 320, and valve seats 314 and 322 as well as other components of the valve assemblies can include one or more materials of high thermal conductivity to facilitate conductive heat transfer of thermal energy received by these valve components from the burning combustion mixture to cylinder block 324 and/or cylinder head 306 and from there to the coolant in the coolant flow channels 326. Materials with high thermal conductivity that can be used in the valve components include but are not limited to beryllium-copper alloys, aluminum alloys, or the like. A shroud or other turbulence-inducing element 340 can be included near the opening of the inlet port 302 into the combustion volume of the cylinder 404. This shroud or other turbulence inducing element 340 can force fluid flow passing form the inlet port 302 into the combustion volume to divert into the combustion volume in a manner that can cause a tumbling motion that can give rise to turbulence of the resulting combustion mixture within the combustion volume.

FIG. 4 shows another example of a part of an engine 400 having an alternative valve configuration to that described above that is nonetheless consistent with providing one or more of the advantages of the current subject matter. In addition to or as an alternative to one or more of the features shown in FIG. 3, one or valve assemblies can include features that allow oil or another coolant fluid (e.g. water, a solution of water in anti-freeze, etc.) to flow through the valve stem 312 or 320 to near the valve head 310 or 316 and back out to thereby convect away excess thermal energy received by valve components from the burning combustion mixture. As shown in FIG. 4, each valve stem 312 or 320 can include an axial coolant input channel 402 that conducts the coolant to near the valve head 310 or 316. The coolant can then flow back out of the valve stem through a coolant output channel 404 that can be annular, parallel, etc. to the coolant inlet channel 402. A similar result can be obtained using an alternative configuration in which finger followers for an overhead cam have a forked end for the rocker arm 334.

In some implementations of the current subject matter, lean operation can be used in combination with a variable compression ratio and optionally with increased effectiveness of the application of ignition energy (explained in more detail below) to achieve reliable combustion stability in this highly lean combustion mixture regime. A variable compression approach can be applied in which the compression ratio is reduced as the power density is increased. At very light loads, a very high compression ratio can be used such that the fluid volume surrounding the spark plug is at a high enough temperature that it causes little quenching of the flame. The temperature difference that can be supported between the flame and the surroundings is generally dependent on the amount of fuel in the volume. Therefore, as the amount of fuel goes up, the compression ratio can come down and still support stable combustion. As such, the compression ratio can also be advantageously reduced as the amount of fuel increases such that as the combustion mixture burns, the temperatures do not become so high that NO_{X} begins to form. Avoidance of knock or auto-ignition can also drive the compression ratio lower, so that even with a knock sensitive air-to-fuel ratio or engine load, the reduced compression ratio engine will not experience auto-ignition or knock. In this way ignition timing can be advanced to give maximum brake torque timing and high load efficiency advantages can be realized. In an example, an engine can run at an elevated compression ratio (e.g. approximately 15:1, or alternatively as high as 20:1) at a first air-to-fuel ratio (e.g. λ˜1.4) for low power requirements but at a reduced compression ratio (e.g. approximately 10:1) for maximum torque at a second, lower air-to-fuel ratio (e.g. λ˜1) to mitigate knock or auto-ignition.

Additional or alternative implementations of the current subject matter can include enhancing the ignition energy delivered to a combustion mixture, for example at one or more spark plugs. Ignition energy can be enhanced or otherwise varied via a number of approaches. One method involves increasing the spark length by increasing the physical gap length of the spark plug and increasing the voltage across the gap so that the spark can still arc across the gap. This approach can deliver more energy into the initial flame kernel so that it can overcome the cooling from the surrounding gas, while the kernel becomes big enough to be self-supporting. Additionally, as shown in U.S. Pat. No. 7,098,581, techniques can be used to distribute the available energy available over a larger volume. Yet another variant consistent with one or more implementations of the current subject matter can involve firing a spark plug or other ignition source 330 multiple times in succession as a fuel-air mixture moves past the ignition point. Multiple flame front propagating surfaces can be made available to reduce the odds of extinguishing and hence increase combustion stability.

Test data collected by the inventors has indicated that certain engines can achieve the Euro 5 emissions standard of 2 grams of NO_{X} per kilowatt-hour of operation at approximately 50% excess air (e.g. λ˜1.5) without the use of after treatment. In small vehicles, such as for example motorcycles with engine displacements in a range of approximately 100 cm³ to 125 cm³, an approach involving use of a combustion mixture with a very lean air-to-fuel ratio can allow production of less than 60 milligrams per kilometer, thereby enabling satisfaction of Euro 5 and Euro 6 NO_{X} specifications.

In some variations of the current subject matter, the peak temperature of the combustion event can be limited or otherwise controlled to a lower value by adding exhaust gas to the combustion mixture, for example via the intake port using an exhaust gas recirculation manifold. The already burned mixture can provide an inert (or at least less reactive) diluent that can allow lower fuel density in the burn without resulting in excess oxygen in the exhaust stream that can complicate treatment of formed NO_{X}. However, such exhaust gas recirculation (EGR) may not be as advantageous an approach because of the undesirable effect of providing larger amounts of tri-atomic gases in the combustion volume. Tri-atomic gases, because of their reduced polytrophic coefficient, are thermodynamically less efficient at turning heat into work than are diatomic gases such as N₂ and O₂. The compression ratio variation described above can also be used with EGR. However the exact amount of EGR can be dependent on the temperature of the exhaust gas, its reactivity, and the amounts of carbon monoxide and unburned hydrocarbons that it contains.

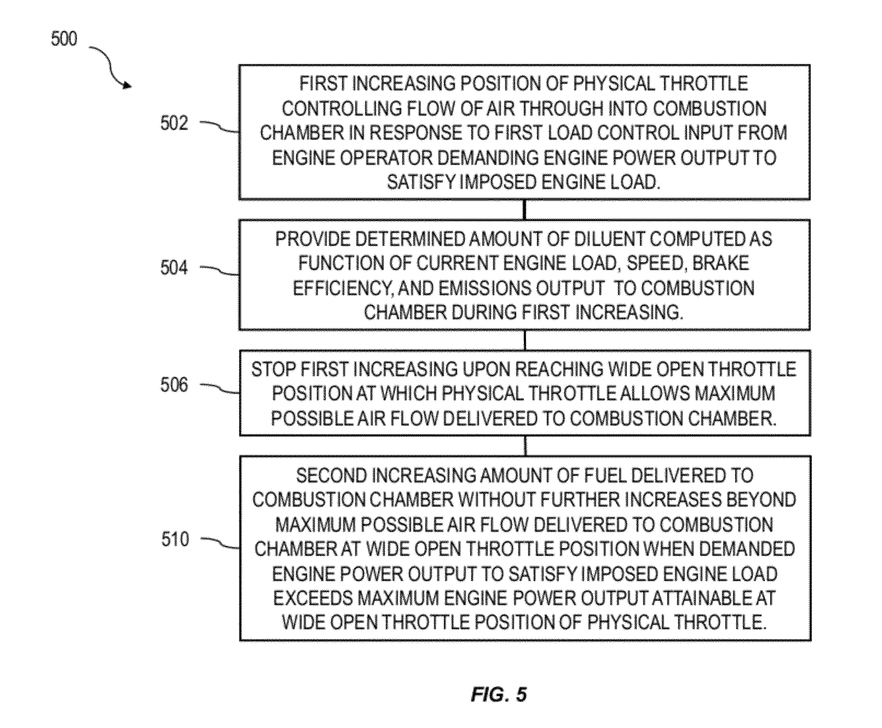

FIG. 5 shows a process flow chart 500 illustrating method features, one or more of which are consistent with at least one implementation of the current subject matter. At 502, in response to a first load control input from an engine operator demanding an engine power output to satisfy an imposed engine load a position of a physical throttle controlling flow of air through an air intake into a combustion chamber of an internal combustion engine can be increased. A correlation between the position of the physical throttle and the first load control input need not be linear. In other words a relationship between an amount of motion of the physical throttle and an amount of motion of the load control input received from the engine operator can be less than 1:1.

During the first increasing, at 504 a determined amount of a diluent can be provided to the combustion chamber. The amount of the diluent can have been computed as a function of a current engine load, a current engine speed, a current engine brake efficiency, and a current emissions output. At 506, the first increasing can be stopped upon reaching a wide open throttle position at which the physical throttle allows a maximum possible air flow delivered to the combustion chamber. At 510, when the demanded engine power output to satisfy the imposed engine load exceeds a maximum engine power output attainable at the wide open throttle position of the physical throttle, an amount of fuel delivered to the combustion chamber can be increased. The increasing of the amount of fuel can occur without further increases beyond the maximum possible air flow delivered to the combustion chamber at the wide open throttle position.

The operating air-to-fuel ratio in the combustion mixture within the combustion chamber can be variable depending on the engine operating point, which can include the current engine load and engine speed. Engine operation parameters monitored in conjunction with implementations of the current subject matter can include one or more of an intake manifold temperature and pressure, a current throttle setting or engine power requirement, detection of auto-ignition or knock in the combustion chamber, coolant temperature, altitude, type of fuel being used, the exhaust gas temperature, the exhaust gas oxygen content, and the like. The type of fuel being used can be identified as a type of alcohol-containing fuel (for example E10 or E85 alcohol), an octane rating (for example, 87, 98, 91, etc.) or simply above or below a threshold to quantify high or low octane. The controller device can, in some implementations, determine fuel type parameters based on data from a knock sensor (e.g. an auto-ignition sensor) and the required ignition timing required to avoid knock by a comparison to a look up table or other database.

In some implementations of the current subject matter, when the second increasing occurs, if recirculated exhaust gases are used s the diluent, then, during full throttle load demand increases, an EGR valve can begin closing to allow additional (fresh) air into the engine. In one example, fuel and airflow can increase to maintain a stoichiometric or nearly stoichiometric air-to-fuel ratio for the combustion mixture while the physical throttle remains at 100%. When a full engine load is reached with the engine operating at a stoichiometric or nearly stoichiometric air-to-fuel ratio, the EGR valve is fully closed such that further enrichment of the combustion mixture can occur. Other air-to-fuel ratios are also possible. As a non-limiting example, an EGR approach can include three different operating regimes. At light loads (e.g. during the first increasing 502 discussed above, both the physical throttle and the EGR valve can change with differing engine load and engine speed. Fuelling can be provided for a stoichiometric or nearly stoichiometric air-to-fuel ratio. The physical throttle can increase with increasing load, and the EGR valve operation can be variable to meet flammability limits, maximum efficiency, and emissions criteria. This regime can end when a wide open throttle condition is reached for the physical throttle. In these examples, the amount of EGR can be varied to whatever amount needed to maintain a balance. In a second regime, the EGR valve begins to close while the physical throttle remains fully open, and fuel flow is increased proportionally to airflow. In a third regime, the EGR valve can be fully closed with the physical throttle fully open, and enrichment by increases only in fuel flow with airflow remaining fixed and an amount of EGR at a minimum can be used to respond to additional load demands.

The features explained in reference to FIG. 5 and elsewhere herein can be applied in opposed piston or conventional (i.e. non-opposed piston) engines with one or more combustion chambers, including those operating in either of a four-stroke cycle (e.g., induction, compression, expansion, exhaust) or a two-stroke cycle. Optimization of one or more of an amount turbulence in the combustion chamber, a compression ratio, and a richness (e.g. an air-to-fuel ratio) of a combustion mixture in the combustion chamber can be used to avoid knock or auto-ignition at inlet manifold pressures greater than 0.7 atmospheres.

A burn duration can be a function of one or more factors, including but not limited to a current engine load, an air-to-fuel ratio in a combustion mixture, a current engine speed, an amount of turbulent energy within the combustion chamber, and the like. In some implementations of the current subject matter, the burn duration decreases with increasing load. For example, in a specific engine, a burn duration of approximately 40° of crankshaft rotation can occur at an engine load (BMEP) of approximately 1 bar with an air-to-fuel ratio that is approximately 1.4 times the stoichiometric air-to-fuel ratio (λ=1.4). The same engine at a higher load, for example a BMEP of approximately 5 bar, can have a burn duration of approximately 22° of crankshaft rotation. The burn duration can also be affected by engine speed. In general, more crank angle rotation can be required for a similar engine load and combustion mixture air-to-fuel ratio with higher engine speed. From a turbulence delivery perspective, achievement of optimal efficiency and emissions) performance can be improved by the use of increased turbulence within the combustion chamber. For example, higher turbulence at light loads and lower turbulence at high loads can be beneficial in providing one or more of the advantages available from implementations of the current subject matter.

In various non-limiting examples, a maximum burn duration of approximately 50° of crankshaft rotation or optionally of 40° of crankshaft rotation can be provided through inducement of sufficient tumble in air or other fluids delivered to the combustion chamber, a compression ratio sufficient to approach but not exceed an auto-ignition threshold, and an air-to-fuel ratio in the combustion mixture that is sufficiently lean to minimize NOx production. In other non-limiting examples, a 10% to 90% burn duration of less than approximately 40° of crankshaft rotation can occur for an engine operating at λ of approximately 1.4, an engine load of approximately 1 bar BMEP, and an engine speed of 4000 RPM. In a further non-limiting example, an engine can demonstrate a 10% to 90% burn duration of less than approximately 25° of crankshaft rotation at λ of approximately 1.4, an engine load of approximately 5 bar BMEP, and an engine speed of 4000 RPM.

Compression ratios in excess of 13:1 or alternatively in excess of 15:1 or even 20:1 can be used in conjunction with lean operation up to wide open throttle and MBT spark timing combined with enrichment and spark retardation to increase power beyond the wide operation position of the physical throttle. A stratified or unstratified charge can be supplied to the combustion chamber as necessary, and stratification can optionally be varied depending on engine load and engine speed. The values for the burn duration given above are illustrative examples and are not meant to be limiting. Consistent with various implementations of the current subject matter, the tumble induced can be sufficient to achieve a burn duration of less than approximately 50° of crankshaft rotation, less than approximately 40° of crankshaft rotation, less than approximately 30° of crankshaft rotation, less than approximately 25° of crankshaft rotation, or the like, depending on one or more of the current engine load, air-to-fuel ratio of the combustion mixture, engine speed, or one or more other factors.

A peak pressure angle of between approximately 5° and 20° of crankshaft rotation after top dead center can be achieved for mixtures leaner than 1.2 times the stoichiometric air-to-fuel ratio (λ=1.2) for naturally aspirated with compression ratios greater than approximately 13:1 up to approximately 8 bar IMEP. In some implementations of the current subject matter, features such as those described herein can ensure that all fuel is burned before approximately 7:1, or optionally before approximately 6:1 remaining expansion ratio is reached, even at fully retarded ignition timing for richer mixtures. A combination of high compression ratios (e.g. greater than approximately 13:1) with a diluted combustion mixture (e.g. using approximately 20% excess air or recirculated exhaust gases) and adjustments to the burn duration with turbulence can be used to achieve, for example, a 10-90% burn duration of less than approximately 50° of crankshaft rotation at an engine speed of 2000 rpm or greater. Alternatively or in addition, the factors noted above can be combined to provide a 10-90% burn duration of less than approximately 40° of crankshaft rotation, less than approximately 30° of crankshaft rotation, less than approximately 25° of crankshaft rotation, or the like depending on one or more of the current engine load, air-to-fuel ratio of the combustion mixture, engine speed, or one or more other factors.

For simplicity, reference is generally made herein to a single combustion chamber, but such descriptions are applicable to multiple combustion chamber engines. Intake air can be delivered to the combustion chamber via an air intake, and flow through the air intake can be controlled via a physical throttle or a comparable device that meters air flow through an air intake. Fuel can be delivered to the combustion chamber by a fuel delivery system that can include a fuel injection system (for example computer-controlled injection through one or more injectors positioned within the combustion chamber, in the air intake, in the intake manifold, etc.), a carburetor, or the like. The fuel delivery system can be capable of providing a specific air-to-fuel ratio consistent with the current engine speed and load. With a fuel injection system, variation of the air-to-fuel ratio can be relatively straightforward as the fuel delivery rate and air flow rate are not linked. In a conventional carbureted fuel delivery system, however, fuel is commonly entrained at a relatively constant ratio to the flow of air. Accordingly it can be advantageous to utilize a mixture controlled carburetor, such as for example those described in international patent application no. PCT/US2011/055502, which is capable of varying and controlling a delivered air-to-fuel ratio independently of air flow through the air intake as controlled by the physical throttle.

A flammability limit can in some implementations of the current subject matter, be defined by a coefficient of variation (COV) of net indicated mean effective pressure (NIMEP) in the combustion chamber and can be for example less than approximately 8%. Alternative flammability limit definitions can include, but is not limited to a 0-10% apparent heat release angle (e.g., less than approximately 40° of crankshaft rotation), a lowest normalized value (LNV) of net indicated mean effective pressure (NIMEP) (e.g., limited to greater than approximately 75%), COV of torque (e.g., limited to less than approximately 5%), or other parameters. As an aside, LNV is a standard metric for engine idle stability criteria in which a lowest value in a set of data is divided by the mean value for the set. A flammability limit can be manipulated at each current engine load and current engine speed through operations of at least one of a compression ratio control system (e.g., higher compression ratio for light loads to increase the charge density of the combustion mixture), a turbulence control system, an ignition control system, and a diluent flow control system.

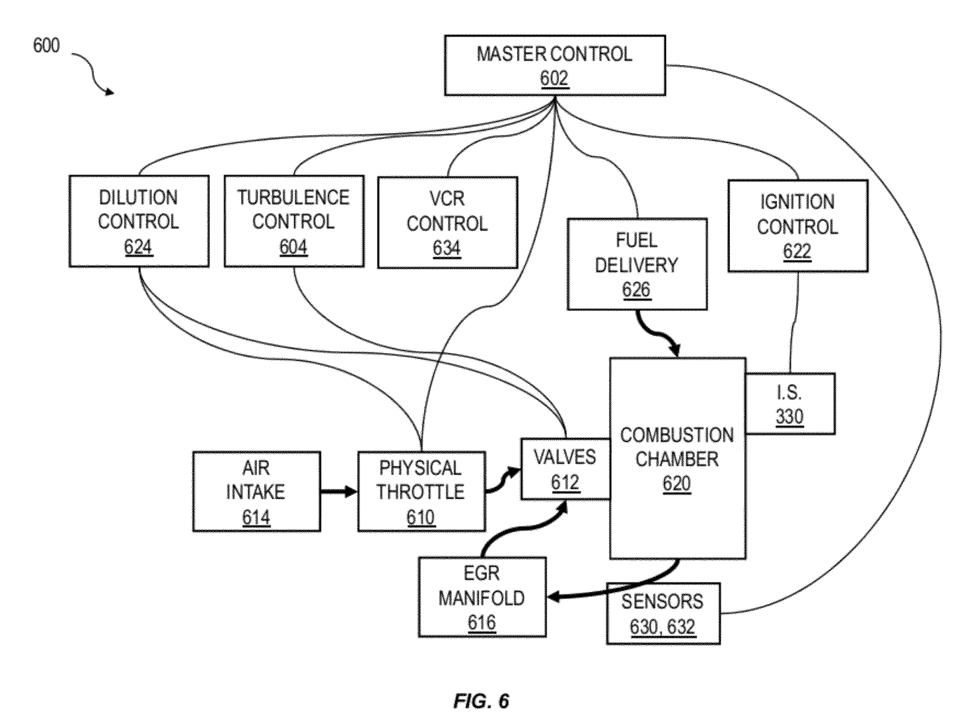

FIG. 6 shows a diagram of a features of an engine control architecture 600 having one or more features that can be incorporated into an engine realizing one or more of the advantage of implementations of the current subject matter. As the diagram 600 of FIG. 6 illustrates a number of concepts of both control systems and physical features of an engine, neither the absolute nor relative arrangement of the elements shown in FIG. 6 should be construed as limiting in any way.

Referring again to FIG. 6, under the control of a master control system 602, which can optionally include an electronic control unit, a turbulence control subsystem 604 consistent with one or more implementations of the current subject matter can optionally include one or more of a turbulence flap or a blade, drum, shaft, or the like associated with an air intake passage 606 or with a physical throttle 610; a mechanism or control system for selectively activating and deactivating one or more intake or exhaust gas recirculation valves 612 to induce a variable level of tumble or swirl in fluids (e.g. one of more fluids or mixtures of fluid including one or more of air delivered from an air intake passage 606, fuel, and recirculated exhaust gases delivered from an EGR manifold 616) introduced into a combustion chamber 620, or the like. The turbulence control system can, at lighter engine loads, dynamically vary one or more of the above-noted components to induce generation of a maximum amount of turbulence while reducing a generated amount of turbulence at higher loads as the richness of the combustion mixture is increased.

Continuing in reference to FIG. 6, an ignition control subsystem 622 consistent with one or more implementations of the current subject matter can optionally implement one or more engine load and engine speed-based variations of ignition energy delivery location, ignition energy delivery timing, ignition energy delivery duration, and ignition energy quantity by dynamic control of one or more ignition sources 330. In other words, the ignition control subsystem 622 can determine, based on a current engine load and current engine speed, a location, timing, duration, and energy quantity for one or more deliveries of spark or other ignition energy from one or more ignition sources 330 to the combustion mixture in the combustion chamber 620. In some implementations of the current subject matter, at least one of a larger quantity of ignition energy delivered and a longer duration over which the ignition energy is delivered can be used at light loads. As the engine load transitions to higher power output, the ignition control subsystem 622 can transition to providing at least one of a smaller quantity of ignition energy and a shorter duration over which the ignition energy is delivered. During higher power delivery, for example when the engine is operating at a maximum physical throttle position and additional engine load is satisfied by increasing the richness of the combustion mixture, the ignition control subsystem 622 can set the timing of delivery of ignition energy from the one or more ignition sources 330 to one or more of a MBT position, a knock or auto ignition-limited ignition advance, a minimum NOx generation timing, or the like. The total ignition energy delivered can optionally be in a range of approximately 5 mJ to 1000 mJ or higher.

A diluent control subsystem 624 can include controls on flow of a diluent into the combustion chamber. In some implementations of the current subject matter, an engine can utilize a diluent that includes one or more of air provided via the air intake passage 614 and recirculated exhaust gases from the EGR manifold 616. In this manner, EGR can be used to allow the engine to remain very near a stoichiometric mixture ratio. Exhaust gases delivered to the combustion chamber through EGR can be cooled or uncooled. A fuel delivery subsystem 626 of the engine, which can be a fuel injection system, a mixture controlled carburetor, or the like as noted above, can optionally be controlled by the master controller or by other control approaches based on inputs indicative of an amount of EGR flow. Inputs indicative of an amount of EGR flow can include, but are not limited to a position of one or more EGR valves, a pressure difference between a combustion chamber inlet port and a combustion chamber exhaust port, or the like. An amount of EGR flow can optionally be maximized at each current engine load within flammability limits and can, for example, increase with increasing load demand until the physical throttle is fully open, at which time further load increases can be achieved through a reduction in the amount of EGR flow, which can permit additional air and fuel at a stoichiometric ratio to enter the cylinder.

In other implementations of the current subject matter, an engine can utilize recirculated exhaust gases and intake air in combustion as a diluent. The fuel delivery subsystem 626 can in this example accept inputs indicative of both EGR flow and intake air flow. Inputs indicative of both EGR flow and intake air flow can include the above noted inputs indicative of EGR flow and also an intake manifold pressure or the like. If the fuel delivery subsystem 626 is electronically controlled, a combustion mixture air-to-fuel ratio can be controlled in an open or closed loop to a target air-to-fuel ratio utilizing one or more of an oxygen sensor 630 and an air-to-fuel ratio sensor (e.g. a λ sensor) 632 located in the exhaust stream in addition to closed or open loop feedback of an amount of EGR flow.

A variable compression ratio control subsystem 634 can be controlled by the master controller 602 to vary a compression ratio in the combustion chamber 620 in accordance with the constraints noted elsewhere herein of maintaining a stable combustion mixture within the flammability limits, avoiding auto-ignition, and providing maximum fuel efficiency for any specific combination of engine load and engine speed.

Variation of the amount of diluent provided to the combustion chamber can be performed across engine loads and engine speeds such that maximum brake efficiency is achieved at each operating load and speed. In combination with an air-to-fuel ratio in the combustion mixture, one or more of a compression ratio, a cam timing, a amount of delivered turbulence, an ignition control can be optimized for minimum brake specific fuel consumption (BSFC) or maximum brake efficiency. An optimum mixture ratio can be maintained at a value that is richer than the minimum NO_{X} output or flammability limit, for example (e.g., 1.4 lambda for max efficiency instead of 1.7 lambda for minimum NO_{X}).

An engine implementing feature discussed herein can advantageously include one or more modifications to enable variation of one of the set of operating conditions or to minimize the occurrence of auto-ignition or knock. For example, one or more of the approaches illustrated and described in international patent application no. PCT/US2011/027775 can be applied to allow a fluid that includes at least inlet air (and that can, in some implementations include at least one of inlet air, fuel, and exhaust gas) to be delivered to a combustion chamber of an internal combustion engine in a manner that imparts sufficient motion to the fluid to generate at least a threshold amount of turbulence within the combustion chamber. The threshold amount of turbulence can advantageously be in a range of approximately 40 to 400 m²·s⁻².

The threshold amount of turbulence can be sufficient to cause a stable burn of the combustion mixture once ignition is triggered. In other words, the engine can be operated to ensure that the combustion mixture within the combustion chamber 620 is at least at the lower flammability limit such that application of ignition energy from one or more ignition sources 330 causes the combustion mixture to ignite and to burn to at least approximately completion. As used herein, the term flammability limit is intended to refer to the range of proportions of combustible gases (e.g. fuel molecules) in a combustion mixture over which the combustion mixture is capable of being ignited. Gas mixtures that include combustible, oxidizing, and inert gases are only flammable under certain conditions. The lower flammable limit (LFL) describes the leanest mixture that still sustains a flame, i.e. the mixture with the smallest fraction of combustible gas, while the upper flammable limit (UFL) gives the richest flammable mixture.

In some implementations, the threshold amount of turbulence can be such that a peak pressure within the combustion chamber is achieved and a 10% to 90% burn duration of the mixture occurs prior to the piston or pistons reaching a position that is approximately 35° past TDC, or alternatively between approximately 10° and 35° past TDC. In some implementations, the fluid can be delivered at a temperature below a first target temperature, for example by actively cooling the air (e.g. via a heat exchanger or the like) routing the air through one or more ducts that are shielded or physically separated from sources of excessive heat within the engine compartment.

Consistent with the descriptions and illustrations of international patent application no. PCT/US2011/027775, the internal surfaces within the combustion volume that come into contact with a mixture of the inlet air and a fuel prior to completion of a burn of the mixture can also be maintained at or below a second target temperature that can, in some implementations be less than a piston crown temperature at operating conditions of the engine. The first and/or the second threshold temperatures can be selected to reduce the tendency of the fuel-air mixture to auto-ignite and/or to cause knock.

In some implementations of the current subject matter, the air-to-fuel ratio can be continuously or semi-continuously varied from a value of approximately λ=0.8 to a value of approximately λ=2 or greater while a compression ratio of the combustion volume can also be continuously or semi-continuously varied from approximately 10:1 to as high as approximately 15:1 or approximately 20:1 for less rich combustion mixtures. The energy delivered by the one or more ignition sources can also be varied, with increased energy delivery and also optionally greater spatial separation of energy delivery applied at less rich combustion mixtures. Ignition timing can be continuously or semi-continuously varied as necessary to maintain reliable combustion conditions without creating conditions that support auto-ignition. In some examples, the ignition timing can be varied within a range of approximately 10° of crankshaft rotation before and 40° of crankshaft rotation after a spark advance that gives maximum brake torque (MBT). In other examples, the ignition timing can be varied within a range of approximately at MBT and 40° of crankshaft rotation after a spark advance that gives maximum brake torque (MBT). Alternatively, the range of ignition timing variation can be between approximately maximum brake torque and later than maximum brake torque, between approximately 0° of crankshaft rotation and approximately 40° of crankshaft rotation after MBT, or the like. Exhaust gas recirculation can be applied as necessary to reduce pumping work and reduce pre-ignition by delivery of inert diluents to the combustion volume.

As a non-limiting example, the power and hence torque or load output of the engine can be increased by progressively decreasing the air-to-fuel ratio (λ), for example by moving from highly lean to less lean (e.g. closer to a stoichiometric mixture of λ=1). The ignition timing can be at or near maximum brake torque (MBT) at lowest power. In this example, the spark timing can be retarded as necessary to reduce knock, as can the compression ratio. As the load on the engine increases, auto-ignition can be avoided by be progressively retarding the ignition timing from MBT and/or the compression ratio can be decreased. As the mixture richness is increased (e.g. λ decreases towards 1), the ignition energy and the spatial and/or temporal distribution over which the ignition energy is delivered can be reduced. For example, leaner mixtures and lower compression ratios may require higher ignition energies and/or spatial or temporal distribution of that ignition energy delivery to be increased to maintain combustion stability. Ignition energy delivered to the combustion mixture can be achieved by one or more of increasing energy delivery at a single point or by delivering ignition energy to multiple points within the combustion mixture (e.g. by multiple physical ignition points or by successive firing from a single ignition point as discussed in more detail below). As the mixture richness and/or the compression ratio increases, the density of fuel molecules at maximum compression increases, and, though the breakdown voltage (e.g. for a spark ignition source) is higher, the necessary ignition power and/or distribution can be reduced while still maintaining combustion stability.

Delivery of ignition energy can be varied according to implementations of the current subject matter using one or more of several possible approaches. The period of time over which delivery of the ignition energy occurs can be varied such that the set of engine operating conditions includes a delivered ignition power and a duration over which that ignition power is delivered. In one example, an ignition source (e.g. spark plug) can provide 40 W of power, and can be configured to provide that constant amount of power over differing periods of time (e.g. 3 ms, 6 ms, 20 ms, etc.) to provide differing total energy deliveries (e.g. 120 mJ, 240 mJ, 800 mJ, etc.).

In various implementations, variable ignition duration and the ability to fire the spark plug or other ignition source repeatedly and successively over a small period of time can advantageously be applied to deliver smaller amounts of energy to multiple sites within a combustion mixture. A small portion of the total delivered energy can be enough to start ignition. As such, by firing many times in succession throughout a combustion mixture (either by having multiple ignition sources 330 distributed spatially about the combustion chamber 620 or by imparting rotational or other motion to the combustion mixture in the combustion chamber 620 such that successive firings from a single ignition source 330 affect different parts of the combustion mixture), multiple distributed flame kernels can be produced. By properly timing the multiple ignition events, the distributed flame kernels can be caused to merge into a larger kernel that is then capable of self-sustaining. A multi electrode spark plug such as is described in co-owned U.S. Pat. No. 7,098,581 can perform a similar function. Such a plug needs to fire only once, however, due to its multiple electrodes, multiple arcs can be distributed over a volume to create multiple flame kernels that merge into a large volume.

The above descriptions address a number of features of engines that can enhance aspects of the operation of the engine to provide one or more of the benefits of the current subject matter as explained herein. However, the current subject matter can be used to operate a wide variety of different engines in which one or more of the features described above can be included or omitted in any feasible combination.

Some implementations of the current subject matter can enable higher compression ratios when compared to previously available approaches for a same engine running on the same fuel for a given auto-ignition margin. For example, a gasoline engine using 87 octane gasoline as its fuel can attain a compression ratio of approximately 15:1 or even approximately 20:1 at MBT spark timing without knocking. The compression ratio attainable may be higher or lower than this example.

As noted above, a factor contributing to a high auto-ignition margin and compression ratio can be turbulence, for example turbulence induced as air or other fluids are introduced into the combustion chamber during an inlet stroke of one or more pistons associated with the combustion chamber. Turbulence in the combustion mixture can promote rapid burning of the mixture. Rapid burning can increase engine efficiency at least in part because short burn durations allow the energy released from the fuel to act on the piston for a longer portion of the stroke, thereby producing more work than a slower burning combustion event. Enhanced turbulence provided by one or more features consistent with implementations of the current subject matter can allow lean combustion mixtures to burn as quickly as a stoichiometric mixture might burn in a less turbulent environment. Mixtures with closer to stoichiometric air-to-fuel ratios and enhanced turbulence can burn even more quickly. The determination of MBT timing can be determined in a known manner based at least in part on air flow, engine load, speed, mixture ratio, turbulence and a given type of fuel.

Port shape and valve configuration can be used to impart turbulence to a combustion mixture. Alternatively or in addition, a piston-to-piston interaction (e.g. in an opposed piston engine) or a piston to cylinder head interaction (e.g. in a single piston per cylinder engine configuration) can be used to generate the necessary turbulence. If one portion of the piston is brought very close to either of the opposing piston or the cylinder head while another portion is not, the combustion mixture can be forced out of the close region into the larger volume. This action can give the mixture enough momentum to induce significant turbulence in the larger volume in an approach that is typically referred to as squish.

Another factor that can reduce auto-ignition and thereby enable increases in the compression ratio without knock is the reduction in hot spots within an engine. As noted above, hot spots within the combustion chamber can create localized knocking, and the compression ratio of conventional engines must generally be adjusted downward to account for this. An engine having fewer hot spots than conventional engines can operate at a higher compression ratio. A sleeve valve can provide advantages in minimizing elevated valve temperatures, which can be a significant contributor to hot spots. Poppet valves may also be used in association with one or more active or passive cooling features.

Another factor contributing to the ability to attain the high compression ratios described herein is the relatively cool surface temperatures of the walls around the combustion chamber. In particular, an engine including walls that are cooled by a cooling fluid flowing around the combustion chamber can have a reduced likelihood of spontaneous ignition of end gas during the combustion process, thus allowing further improvements in the compression ratio. In some implementations of the current subject matter, the internal surfaces of the combustion chamber (e.g., the cylinder walls, piston crown(s), valve surfaces, and the like) can advantageously be maintained at a second target temperature below approximately 450° F. (approximately 235° C.).

Other factors can also be employed in addition to or as alternatives to those discussed above. To improve efficiency at low to mid range load a lean combustion mixture, i.e. one having an air-to-fuel ratio (λ) larger than 1 (i.e. higher than stoichiometric), can be used. To reduce power, conventional engines typically throttle the combustion mixture, resulting in pumping losses across the throttle reducing engine efficiency. However, the same effect of reduced power can be achieved according to implementations of the current subject matter by running at wide open throttle (WOT) using a lean combustion mixture, thereby reducing or eliminating pumping losses and the resulting negative impacts on efficiency. A lean combustion mixture can also allow an increase in the compression ratio, as lean combustion mixtures burn at lower temperatures and pressures and so offer auto-ignition resistance.

Using a lean combustion mixture can provide additional benefits in some implementations. The lower temperature burn can result in a lower temperature differential and lower energy/heat losses through the chamber walls at a given load at a given speed. Use of a lean combustion mixture can also provide more sensible heat to the combustion chamber and result in better fuel conversion efficiency as lean operation can result in more generation of and less dissociation of triatomic molecules (CO₂ and H₂O). Additionally, the final (lean) mixture contains a higher proportion of diatomic molecules due to the excess N₂ and O₂, so the polytropic coefficient will be increased, which can yield a higher indicated cycle efficiency. Accordingly, the burned and unburned products can have physical and chemical properties that more closely resemble diatomic nitrogen (N₂) than tri-atomic carbon dioxide (CO₂) and water (H₂O). Diatomic gases typically have higher specific heat ratio than tri-atomic gases, thereby giving lean combustion mixtures inherently higher thermodynamic efficiency. A further benefit to the use of a lean combustion mixture is the production of reduced levels of nitrogen oxides (NO_{X}) because of the lower combustion temperatures.

At moderate compression ratios, the density of the mixture at spark initiation can in some cases be too low to support reliable combustion of a very lean combustion mixture. However, because the current subject matter allows a high compression ratio, the density of the mixture is high enough to enable engine operation with such leaner mixtures, in some examples with a lambda of as much as 1.5 to 2. Even leaner mixtures are within the scope of the current subject matter. Large natural gas engines can employ heavy turbocharging to increase the combustion mixture density sufficiently to run over 2 times as much air as needed. Implementations of the current subject matter can achieve these high densities without the cost and complexity associated with turbocharging. One drawback to the use of lean combustion mixtures is a resulting low power density. However, for higher loads, implementations of the current subject matter can step or gradually increase to a richer mixture approaching and/or exceeding stoichiometric.

Another factor improving efficiency can in some implementations be a reduced combustion volume surface area. A smaller surface area of the cool walls in such an engine can reduce the area from which heat is able to escape. This feature can increase the heat available to do work in the system, with an accompanying increase in efficiency.

Each of the features described herein can contribute to enhanced efficiency. Any one of these features, by itself, can enable an increase in the compression ratio and/or efficiency of an engine as well as a reduction in NO_{X} generation. Various features described herein may therefore be omitted or used in any feasible combination while providing an increased compression ratio and/or efficiency and/or reductions in NO_{X} in accordance with implementations of the current subject matter.

Conventional operation of higher octane fuels can also be achieved using features described herein. Natural gas can be run with close to MBT timing at a geometric compression ratio of 15:1 also giving 35% peak efficiency in a small engine, for example an engine with approximately 250 cm³ of displacement. In one example, natural gas can be used as a fuel with an approximately 18:1 or greater compression ratio. For a dedicated natural gas engine, such compression ratios are readily achievable. However, in automotive applications where natural gas is used, it can be advantageous to be able to switch back and forth between natural gas and gasoline or other fuels. With an engine set up using the lean over-compressed operation for gasoline and conventional operation with natural gas, both fuels can be used at 15:1 geometric compression ratio and only the ignition timing needs to be changed. With the addition of VCR operation, both fuels can be optimized.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, for example as would a non-transient solid-state memory or a magnetic hard drive or any equivalent storage medium. The machine-readable medium can alternatively or additionally store such machine instructions in a transient manner, for example as would a processor cache or other random access memory associated with one or more physical processor cores.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations or embodiments may be within the scope of the following claim.

What is claimed:

1. A method comprising:
first increasing, in response to a first load control input from an engine operator demanding an engine power output to satisfy an imposed engine load, a position of a physical throttle controlling flow of air through an air intake into a combustion chamber of an internal combustion engine;
providing, during the first increasing, a determined amount of a diluent to the combustion chamber, the amount of the diluent having been computed as a function of a current engine load, a current engine speed, a current engine brake efficiency, and a current emissions output;
stopping the first increasing upon reaching a wide open throttle position at which the physical throttle allows a maximum possible air flow delivered to the combustion chamber; and
second increasing, when the demanded engine power output to satisfy the imposed engine load exceeds a maximum engine power output attainable at the wide open throttle position of the physical throttle, an amount of fuel delivered to the combustion chamber, the second increasing in the amount of fuel occurring without further increases beyond the maximum possible air flow delivered to the combustion chamber at the wide open throttle position.

2. A method as in claim 1, further comprising at least one of:
first dynamically varying a compression ratio throughout at least one of the first increasing and the second increasing, the first dynamically varying at least in part maintaining a stable combustion mixture within a flammability limit, avoiding auto-ignition of the combustion mixture within the combustion chamber, and providing a maximum fuel efficiency for any specific combination of a current engine load and a current engine speed;
second dynamically varying, as part of the providing, at least one of an operation mode of one or more valves to increase flow of the diluent to achieve the maximum amount of the diluent and the physical throttle position to increase the flow of intake air to the combustion chamber, the second dynamically varying at least in part maintaining the stable combustion mixture within the flammability limit, avoiding auto-ignition of the combustion mixture within the combustion chamber, and providing a maximum fuel efficiency for any specific combination of the current engine load and the current engine speed;
third dynamically varying, as part of the first increasing and the second increasing, an air-to-fuel ratio in the combustion chamber to achieve at least one of a maximum fuel efficiency, a minimum generation of hydrocarbons, a minimum generation of carbon monoxide, and a minimum generation of nitrogen oxides and to at least in part maintain the stable combustion mixture within the flammability limit, avoiding auto-ignition of the combustion mixture within the combustion chamber, and providing a maximum fuel efficiency for any specific combination of the current engine load and the current engine speed;
fourth dynamically varying at least one of an ignition timing for delivery of ignition energy from one or more ignition sources, a duration of delivery of the ignition energy from the one or more ignition sources, a number of the one or more ignition sources that delivers the ignition energy, and a location of the number of the one or more ignition sources that delivers the ignition energy to at least part maintain a stable combustion mixture within the flammability limit, avoid auto-ignition of the combustion mixture within the combustion chamber, and provide the maximum fuel efficiency for any specific combination of the current engine load and the current engine speed; and
determining the maximum amount of the diluent, the determining comprising computing the function as constrained by at least the flammability limit of the combustion mixture and minimization of NO_{X} production at the current engine load and the current engine speed.

3. A method as in claim 2, wherein the varying of the operation mode comprises at least one of varying a valve timing, a valve lift, and a valve opening duration for at least one of a exhaust valve and an air intake valve.

4. A method as in claim 2, wherein the flammability limit is defined by at least one of a coefficient of variation (COV) of a net indicated mean effective pressure (NIMEP) in the combustion chamber, a 0-10% apparent heat release angle of crankshaft rotation, a lowest normalized value (LNV) of net indicated mean effective pressure (NIMEP), and a COV of torque.

5. A method as in claim 2, wherein the flammability limit is defined by at least one of the following: the COV of the NIMEP is less than approximately 8%, the 0-10% apparent heat release angle is less than approximately 40° of crankshaft rotation, the LNV of the NIMEP is greater than approximately 75%, and the COV of torque is less than approximately 5%.

6. A method as in claim 1, further comprising using a non-linear correlation between the position of the physical throttle and the first load control input.

7. A method as claim 1, wherein the overall maximum engine output power is achieved at a maximum power air-to-fuel ratio that comprises one of a stoichiometric ratio and a richer than stoichiometric ratio.

8. A method as in claim 1, wherein the diluent comprises at least one of air, cooled recirculated exhaust gases, and uncooled recirculated exhaust gases.

9. A method as in claim 1, further comprising: stopping the second increasing upon reaching either of an overall maximum engine output power or a maximum permissible emissions limit for one or more of NO_{X}, hydrocarbons, and carbon monoxide.

10. A method as in claim 1, further comprising: causing delivery of fuel to the combustion chamber using a fuel delivery system comprising at least one of a fuel injection system and a carburetor capable of varying and controlling a delivered air-to-fuel ratio independently of air flow through an air intake as controlled by the physical throttle.

11. An internal combustion engine comprising:
a combustion chamber;
an air intake;
a physical throttle controlling flow of air through the air intake into the combustion chamber; and
a master control system, the master control system performing operation comprising:
first increasing, in response to a first load control input from an engine operator demanding an engine power output to satisfy an imposed engine load, a position of the physical throttle controlling flow of air through an air intake into the combustion chamber;
providing, during the first increasing, a determined amount of a diluent to the combustion chamber, the amount of the diluent having been computed as a function of a current engine load, a current engine speed, a current engine brake efficiency, and a current emissions output;
stopping the first increasing upon reaching a wide open throttle position at which the physical throttle allows a maximum possible air flow delivered to the combustion chamber; and
second increasing, when the demanded engine power output to satisfy the imposed engine load exceeds a maximum engine power output attainable at the wide open throttle position of the physical throttle, an amount of fuel delivered to the combustion chamber, the second increasing in the amount of fuel occurring without further increases beyond the maximum possible air flow delivered to the combustion chamber at the wide open throttle position.

12. An internal combustion engine as in claim 11, wherein the operations further comprise at least one of:
first dynamically varying a compression ratio throughout at least one of the first increasing and the second increasing, the first dynamically varying at least in part maintaining a stable combustion mixture within a flammability limit, avoiding auto-ignition of the combustion mixture within the combustion chamber, and providing a maximum fuel efficiency for any specific combination of a current engine load and a current engine speed;
second dynamically varying, as part of the providing, at least one of an operation mode of one or more valves to increase flow of the diluent to achieve the maximum amount of the diluent and the physical throttle position to increase the flow of intake air to the combustion chamber, the second dynamically varying at least in part maintaining the stable combustion mixture within the flammability limit, avoiding auto-ignition of the combustion mixture within the combustion chamber, and providing a maximum fuel efficiency for any specific combination of the current engine load and the current engine speed;
third dynamically varying, as part of the first increasing and the second increasing, an air-to-fuel ratio in the combustion chamber to achieve at least one of a maximum fuel efficiency, a minimum generation of hydrocarbons, a minimum generation of carbon monoxide, and a minimum generation of nitrogen oxides and to at least in part maintain the stable combustion mixture within the flammability limit, avoiding auto-ignition of the combustion mixture within the combustion chamber, and providing a maximum fuel efficiency for any specific combination of the current engine load and the current engine speed;
fourth dynamically varying at least one of an ignition timing for delivery of ignition energy from one or more ignition sources, a duration of delivery of the ignition energy from the one or more ignition sources, a number of the one or more ignition sources that delivers the ignition energy, and a location of the number of the one or more ignition sources that delivers the ignition energy to at least part maintain a stable combustion mixture within the flammability limit, avoid auto-ignition of the combustion mixture within the combustion chamber, and provide the maximum fuel efficiency for any specific combination of the current engine load and the current engine speed; and
determining the maximum amount of the diluent, the determining comprising computing the function as constrained by at least the flammability limit of the combustion mixture and minimization of NO_{X} production at the current engine load and the current engine speed.

13. An internal combustion engine as in claim 12, wherein the varying of the operation mode comprises at least one of varying a valve timing, a valve lift, and a valve opening duration for at least one of a exhaust valve and an air intake valve.

14. An internal combustion engine as in claim 12, wherein the flammability limit is defined by at least one of a coefficient of variation (COV) of a net indicated mean effective pressure (NIMEP) in the combustion chamber, a 0-10% apparent heat release angle of crankshaft rotation, a lowest normalized value (LNV) of net indicated mean effective pressure (NIMEP), and a COV of torque.

15. An internal combustion engine as in claim 12, wherein the flammability limit is defined by at least one of the following: the COV of the NIMEP is less than approximately 8%, the 0-10% apparent heat release angle is less than approximately 40° of crankshaft rotation, the LNV of the NIMEP is greater than approximately 75%, and the COV of torque is less than approximately 5%.

16. An internal combustion engine as in claim 11, wherein the operations further comprise using a non-linear correlation between the position of the physical throttle and the first load control input.

17. An internal combustion engine as in claim 11, wherein the overall maximum engine output power is achieved at a maximum power air-to-fuel ratio that comprises one of a stoichiometric ratio and a richer than stoichiometric ratio.

18. An internal combustion engine as in claim 11, wherein the diluent comprises at least one of air, cooled recirculated exhaust gases, and uncooled recirculated exhaust gases.

19. An internal combustion engine as in claim 11, wherein the operations further comprise: stopping the second increasing upon reaching either of an overall maximum engine output power or a maximum permissible emissions limit for one or more of NO_{X}, hydrocarbons, and carbon monoxide.

20. An internal combustion engine as in claim 11, wherein the operations further comprise causing delivery of fuel to the combustion chamber using a fuel delivery system comprising at least one of a fuel injection system and a carburetor capable of varying and controlling a delivered air-to-fuel ratio independently of air flow through an air intake as controlled by the physical throttle.
